(19) United States
(12) Patent Application Publication
(10) Pub. No.: US 2026/0025473 A1
(43) Pub. Date: Jan. 22, 2026

(54) SHEET SUPPLYING APPARATUS, IMAGE READING APPARATUS, AND RECORDING APPARATUS

(71) Applicant: CANON KABUSHIKI KAISHA, Tokyo (JP)

(72) Inventor: KAZUKI MATSUO, Tokyo (JP)

(21) Appl. No.: 19/271,261

(22) Filed: Jul. 16, 2025

(30) Foreign Application Priority Data
Jul. 17, 2024 (JP) 2024-114055

(51) Int. Cl. H04N 1/00

(52) U.S. Cl. CPC H04N 1/00628; H04N 1/00588; H04N 1/00602

(57) ABSTRACT

A sheet supplying apparatus includes, an apparatus body having a shaft portion; a sheet stacking portion; a supplying member; a separation unit that moves between a first position in which the separation unit contacts and separates the sheet supplied from the sheet stacking portion, and a second position in which the separation unit is rotated about the shaft portion from the first position relative to the apparatus body; and a bearing provided in the separation unit, detachable from the shaft portion, and having an opening with a width of a first length in a width direction. A width of the shaft portion in a first direction is greater than the first length, while a width of the shaft portion in a second direction is smaller than the first length.

### BACKGROUND

### Field of the Technology

The present disclosure relates to a sheet supplying apparatus, and also to an image reading apparatus and a recording apparatus each including a sheet supplying apparatus.

### Description of the Related Art

A known sheet supplying apparatus provided in a recording apparatus, an image reading apparatus, or the like includes a stacking portion that stacks sheets, a supplying member that supplies the sheets from the stacking portion, and a separation unit that separates the sheets to be supplied.

Japanese Patent Application Laid-open No. 2019-34807 discloses a configuration including a separation unit having a shaft portion, an apparatus body having a bearing portion with an opening that is open upward, and an urging-member holding member that holds an urging member for urging the separation unit. In this configuration, the urging-member holding member is configured to be rotatable to adjust the orientation of the urging member.

In the aforementioned configuration, the upper side of the bearing portion is open. Therefore, the separation unit may become unintentionally detached from the apparatus body when the separation unit is lifted. Furthermore, when the separation unit is mounted, the posture of the urging-member holding member needs to be adjusted so that the urging member is attached to a specified position of the separation unit.

### SUMMARY

Present disclosure is directed to provide a sheet supplying apparatus that improves the detachment operability of a separation unit.

In order to achieve the object described above, a sheet supplying apparatus according to the present disclosure includes:
an apparatus body having a shaft portion;
a sheet stacking portion that stacks a plurality of sheets;
a supplying member that supplies each of the sheets stacked on the sheet stacking portion;
a separation unit that moves between a first position in which the separation unit contacts and separates the sheet supplied from the sheet stacking portion, and a second position in which the separation unit is rotated about the shaft portion from the first position relative to the apparatus body; and
a bearing provided in the separation unit, detachable from the shaft portion, and having an opening with a width of a first length in a width direction, wherein,
assuming that the width direction of the opening is a first direction in a case where the separation unit is in the first position and that the width direction of the opening is a second direction in a case where the separation unit is in the second position, a width of the shaft portion in the first direction is greater than the first length, while a width of the shaft portion in the second direction is smaller than the first length.

According to the present invention, it is possible to provide a sheet supplying apparatus that improves the detachment operability of a separation unit.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are perspective views of a multifunction peripheral according to a first embodiment, FIG. 1A shows the image reading apparatus 100 with the ADF portion 300 open and FIG. 1B shows the image reading apparatus 100 with the ADF portion 300 closed;

FIGS. 2A and 2B are cross-sectional views of a scanner portion and an ADF portion according to the first embodiment, FIG. 2A shows the cross section of the image reading apparatus 100 along the X-Z plane and FIG. 2B is an enlarged view of an A-portion enclosed by the dotted line in FIG. 2A;

FIGS. 3A to 3C are explanatory views of the scanner portion according to the first embodiment, FIG. 3A is a top view of the scanner portion 200, FIG. 3B is a cross-sectional view taken along the line A-A in FIG. 3A, and FIG. 3C is a cross-sectional view taken along the line B-B in FIG. 3A;

FIG. 4 is a rear view of a glass frame unit according to the first embodiment;

FIG. 5 is a top view of the scanner portion according to the first embodiment;

FIGS. 6A to 6C are explanatory views showing the arrangement position of a separation unit according to the first embodiment, FIG. 6A is a perspective view of the ADF portion 300 with a cover member 361 open, FIG. 6B is a perspective view showing a state in which the separation unit 351 is removed from the placement table 301, and FIG. 6C is an enlarged view of a B-portion enclosed by the dotted line in FIG. 6B;

FIGS. 7A to 7D are explanatory views of the separation unit according to the first embodiment, FIG. 7A is a perspective view of the separation unit 351, FIG. 7B is an exploded perspective view of the separation unit 351, FIG. 7C is a top view of the separation unit 351, and FIG. 7D is a bottom view of the separation unit 351;

FIGS. 8A to 8C are explanatory views showing the mounting state of the separation unit according to the first embodiment, FIG. 8A is a top view of the placement table 301 on which the separation unit 351 is mounted, FIG. 8B is a cross-sectional view taken along the line D-D in FIG. 8A, and FIG. 8C is an enlarged view of a C-portion enclosed by the dotted line in FIG. 8B;

FIGS. 9A to 9D are explanatory views showing a method for mounting the separation unit according to the first embodiment, FIG. 9A shows a state in which the bearing 353a of the separation unit 351 is brought close to the support shaft 301a to mount the separation unit 351, FIG. 9B shows a state in which the separation unit 351 has been rotated from the state shown in FIG. 9A, FIG. 9C shows a state in which the separation unit 351 has been rotated from the state shown in FIG. 9B, and FIG. 9D shows a state in which the separation unit 351 has been rotated from the state shown in FIG. 9C; and

FIGS. 10A and 10D are explanatory views of a bearing and a support shaft according to the first embodiment, FIG. 10A shows the bearing 353a when the separation unit 351 is in the posture shown in FIG. 9B, FIG. 10B shows the configuration of the periphery of the support shaft 301a and the wall portion 301b of the placement table 301, and FIGS. 10C and 10D show the positional relationship between the bearing 353a and the support shaft 301a.

### DESCRIPTION OF THE EMBODIMENTS

Hereinafter, embodiments of the present invention will be specifically described with reference to the drawings. Note that the components described in the following embodiments are merely for illustration. The configurations and various conditions of apparatuses to which the present invention is applied may be modified or changed as appropriate without departing from the spirit of the present invention and are not limited to the following embodiments. For example, the dimensions, materials, shapes, their relative arrangements, or the like of the components described in the following embodiments may be changed as appropriate depending on the configurations and various conditions of the apparatuses to which the present invention is applied. Unless otherwise specifically noted, the present invention is not limited to the following embodiments.

Image reading apparatuses including the sheet supplying apparatus of the present invention are applicable to flatbed scanner apparatuses, copying machines in which flatbed scanner apparatuses are combined with printing apparatuses or the like, facsimile machines, multifunction peripherals, and the like. Furthermore, the sheet supplying apparatus of the present invention is also applicable not only to image reading apparatuses but also to recording apparatuses, such as printers, that include an image recording portion for recording images on sheet-shaped recording media. Hereinafter, an example will be described in which the present invention is applied to an image reading apparatus that captures sheet images into a computer or the like. Note that throughout the respective drawings, the same reference numerals indicate the same or corresponding portions. Furthermore, in the following descriptions and drawings, X, Y, and Z indicate directions that are orthogonal to each other. X, Y, and Z indicate the depth direction, width direction, and height direction of an image reading apparatus 100, respectively.

### First Embodiment

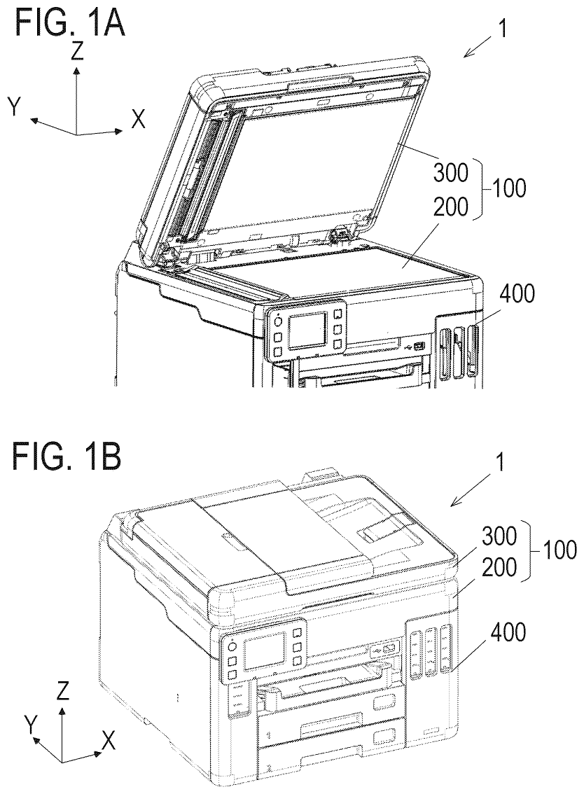

FIGS. 1A and 1B are external perspective views of a multifunction peripheral 1 in which the image reading apparatus 100 according to a first embodiment of the present invention is combined with a printing apparatus 400, which is an inkjet printer. The image reading apparatus 100 is roughly composed of a scanner portion 200, which serves as an image reading portion for reading an image on a sheet, and an ADF portion 300, which is configured to be capable of conveying the sheet. The ADF portion 300 is configured to be openable and closable with respect to the scanner portion 200 to allow a sheet to be placed on the scanner portion 200. FIG. 1A shows the image reading apparatus 100 with the ADF portion 300 open. FIG. 1B shows the image reading apparatus 100 with the ADF portion 300 closed.

### Image Reading Apparatus

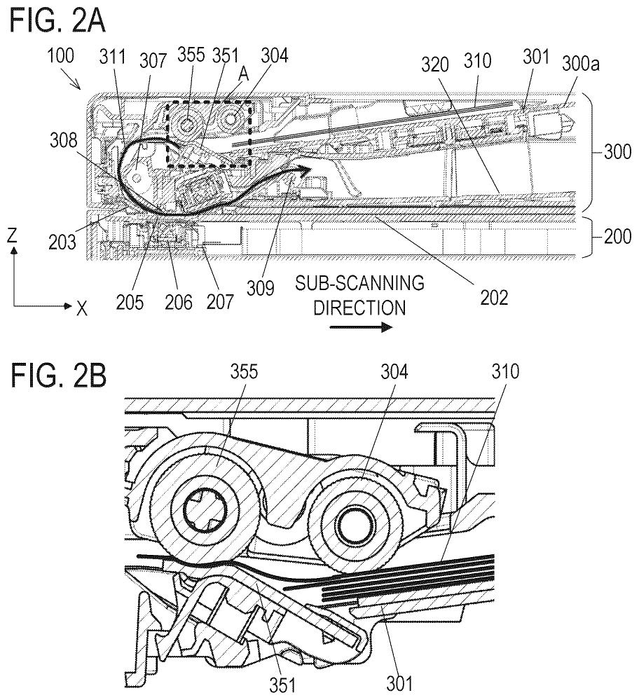

The configuration of the image reading apparatus 100 will be described with reference to FIGS. 2A and 2B. FIGS. 2A and 2B are cross-sectional views of the scanner portion 200 and the ADF portion 300 of the image reading apparatus 100. FIG. 2A shows the cross section of the image reading apparatus 100 along the X-Z plane with the ADF portion 300 closed. FIG. 2B is an enlarged view of an A-portion enclosed by the dotted line in FIG. 2A. In FIG. 2A, the path of a sheet passing through a sheet conveyance path 311 of the ADF portion 300 is shown by a thick solid arrow. A part of the sheet conveyance path 311 is constituted by a part of the scanner portion 200.

The ADF portion 300 includes: a placement table 301, which is a sheet stacking portion capable of stacking a plurality of sheets to be automatically conveyed; a sheet conveyance mechanism portion configured to be capable of conveying the sheets; and a sheet discharging portion 320, on which the discharged sheets are to be stacked. FIG. 2A shows a state in which a plurality of sheets 310 are placed on the placement table 301. The sheet conveyance mechanism portion refers to conveyance means including a sheet conveyance mechanism that extends from a pick-up roller 304 to a discharging roller 309 of the ADF portion 300. In other words, the sheet conveyance mechanism portion may be described as including a conveyance portion, which conveys the sheets 310, and a discharge portion, which includes a discharging roller 309 and discharges the sheets 310.

The ADF portion 300 may be recognized as a kind of sheet supplying device that supplies the sheets 310 by the pick-up roller 304, or as a kind of sheet discharging device that discharges the sheets 310 by the discharging roller 309. The placement table 301 and the sheet discharging portion 320 are components of a device body 300a of the ADF portion 300, which serves as both the sheet supplying device and the sheet discharging device.

A sheet to be automatically conveyed is first placed on the placement table 301, which is provided on the top of the ADF portion 300. The sheet 310 mounted on the placement table 301 is conveyed toward a separation roller 355 by the pick-up roller 304 of the sheet conveyance mechanism portion. The pick-up roller 304 is a supplying member that contacts the sheet 310 stacked on the placement table 301 to supply the sheet 310 in the conveyance direction.

In the conveyance direction of the sheet 310, a sheet separation portion composed of the separation roller 355 and a separation unit 351 is provided downstream of the placement table 301 and the pick-up roller 304. Among the sheets 310 placed on the placement table 301, the sheet 310 at the top is conveyed by the pick-up roller 304 to the sandwiching portion between the separation roller 355 and the separation unit 351.

When the top sheet 310 on the placement table 301 is supplied (conveyed) by the pick-up roller 304, the sheet 310 beneath it may also move in the conveyance direction due to friction between the sheets. However, the lower sheet 310, which is the subsequent sheet, contacts the separation unit 351 and stops after receiving a resisting force in the direction opposite to the movement direction. This configuration makes it possible to separate and convey the sheets 310 individually. The sheets 310 sandwiched between the separation roller 355 and the separation unit 351 are conveyed individually to a conveyance roller 307 on the downstream side in the conveyance direction.

Next, the sheet 310 is conveyed by the conveyance roller 307 to a conveyance guide 203 on the downstream side in the conveyance direction. The conveyance guide 203 is a guide portion provided to be detachable from the image reading apparatus 100. The sheet 310 guided by the conveyance guide 203 is pressed by a white pressing plate 308 and brought into close contact with an ADF glass 205. While the sheet 310 is in close contact with the ADF glass 205, an image on the sheet 310 is read by an image sensor 206. The white pressing plate 308 is sized to cover the entire area of the image sensor 206 in the main scanning direction (Y direction).

The sheet conveyance mechanism portion is provided with various sheet detection sensors that detect the passage of the leading and trailing ends of the sheet 310. The outputs of these sheet detection sensors are used to control the timing for reading images by the image sensor 206.

The image reading apparatus 100 of the present invention has two methods of sheet reading, i.e., sheet-fixed reading (flatbed reading) and sheet-conveyance reading (ADF reading). In the sheet-fixed reading method, a sheet is fixed on a glass table 202 on which the sheet 310 is set, and a reading unit 207 is moved in the sub-scanning direction (X direction) to read the sheet. In the sheet-conveyance reading method, the reading unit 207 is fixed at a specified position (ADF position), and the sheet is read while being conveyed by the ADF portion 300.

In FIG. 2A, the reading unit 207 inside the scanner portion 200 is on standby at an ADF position to read the sheet 310 automatically conveyed by the aforementioned ADF portion 300.

### Scanner Portion

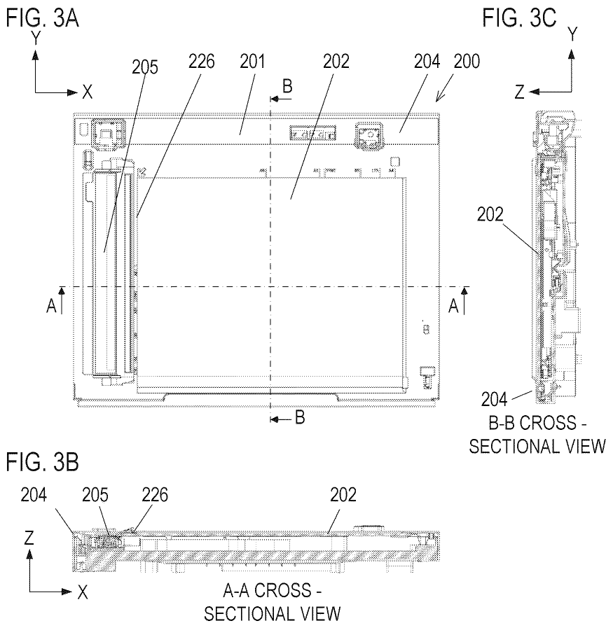

Next, the configuration of the scanner portion 200 of the image reading apparatus 100 will be described in more detail with reference to FIGS. 3A to 3C, 4, and 5. FIGS. 3A to 3C are explanatory views of the scanner portion 200. FIG. 3A is a top view of the scanner portion 200 with the ADF portion 300 removed from the image reading apparatus 100 and shows an entire glass frame unit 201. FIG. 3B is a cross-sectional view taken along the line A-A in FIG. 3A and shows the scanner portion 200 as viewed from the main scanning direction (Y direction). FIG. 3C is a cross-sectional view taken along the line B-B in FIG. 3A and shows the scanner portion 200 as viewed from the sub-scanning direction (X direction).

The glass frame unit 201 is composed of the glass table 202 on which the sheet 310 is placed, the conveyance guide 203 that guides the automatically-conveyed sheet 310, and a glass frame 204 that holds the conveyance guide 203. The conveyance guide 203 is detachably held by the glass frame 204. The glass frame 204 includes a sheet alignment reference 226.

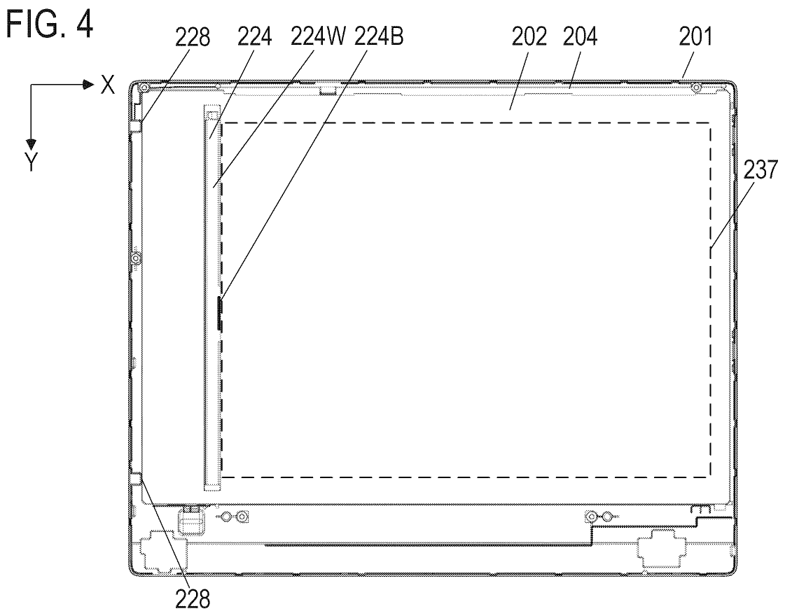

FIG. 4 is a rear view of the glass frame unit 201 in FIG. 3A and shows the glass frame unit 201 as viewed from the side of the printing apparatus 400. On the sheet placement surface side of the glass table 202, a white sheet 224 is arranged. FIG. 4 shows a part of the white sheet 224.

The position of the glass table 202 in the X direction is determined when it is aligned with glass frame alignment portions 228 at two places of the glass frame 204. The white sheet 224 is arranged on the back side of the glass table 202 in the direction of the figure, and on the sheet placement surface. As shown in FIG. 4, the position of the white sheet 224 in the X direction is between the glass frame alignment portion 228 and a stationary sheet reading area 237.

The white sheet 224 integrally includes a white area 224W, which is used for shading correction of the image sensor 206 of the reading unit 207, and a black area 224B, which serves as a reference position for the image sensor 206 in the sub-scanning direction (X direction). In order to perform the shading correction, the white sheet 224 is sized to cover the entire area of the image sensor 206 in the main scanning direction (Y direction). Within the white sheet 224, the position of the black area 224B in the sub-scanning direction is closer to the stationary sheet reading area 237 than the white area 224W.

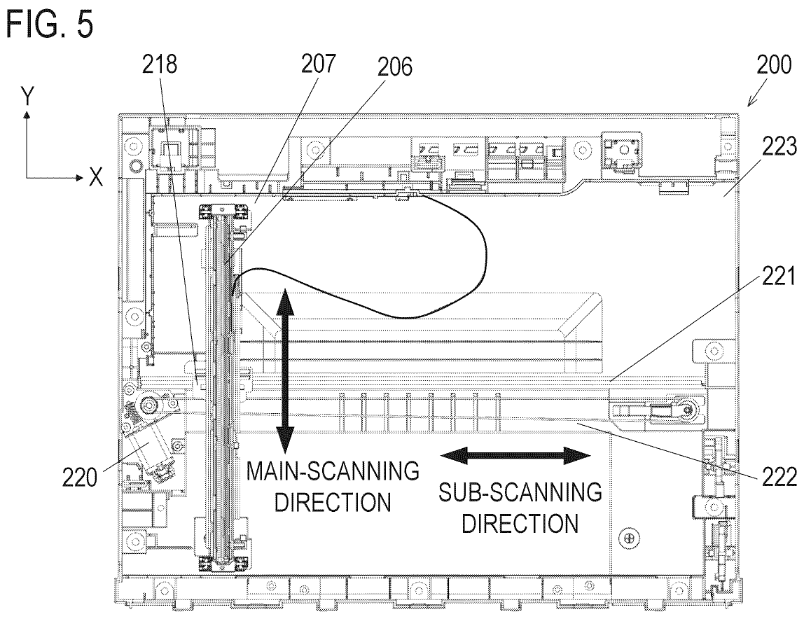

FIG. 5 is a top view of the scanner portion 200 with the glass frame unit 201 removed. The scanner portion 200 includes a motor 220, a guide rail 221, a belt 222, and a base frame 223. FIG. 5 shows the overall internal configuration of the scanner portion 200 and the positional relationship between the reading unit 207 and the base frame 223.

At the central portion of the base frame 223 in the main scanning direction (Y direction), the guide rail 221 is arranged lengthwise in the sub-scanning direction (X direction). Furthermore, a slider 218 of the reading unit 207 is arranged on the guide rail 221 to be slidable in the sub-scanning direction (X direction). The reading unit 207 is connected to the belt 222 through a drive transmission portion. When a drive input is provided to the motor 220, the belt 222 moves accordingly, causing the reading unit 207 to reciprocally scan along the guide rail 221. This configuration allows the reading unit 207 to move in the sub-scanning direction.

Note that in the first embodiment, a belt-driven type is provided in which the driving portion is arranged on the base frame 223, and its driving force is transmitted via the belt 222. However, a self-propelled type reading unit may also be provided in which the driving portion is arranged on the reading unit 207.

### Sheet Separation Portion

The configuration of the sheet separation portion of the ADF portion 300 in the first embodiment will be described in more detail.

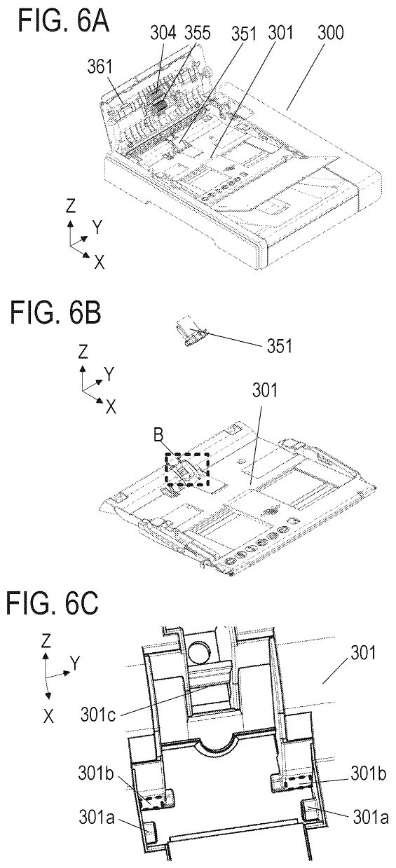

FIGS. 6A to 6C are explanatory views showing the arrangement position of the separation unit 351. FIG. 6A is a perspective view of the ADF portion 300 with a cover member 361 open. FIG. 6B is a perspective view showing a state in which the separation unit 351 is removed from the placement table 301. FIG. 6C is an enlarged view of a B-portion enclosed by the dotted line in FIG. 6B and shows the details of a mounting portion on which the separation unit 351 is mounted.

The placement table 301 has a support shaft 301a that is used to mount the separation unit 351 on the placement table 301. The separation unit 351 is configured to be detachable from the support shaft 301a.

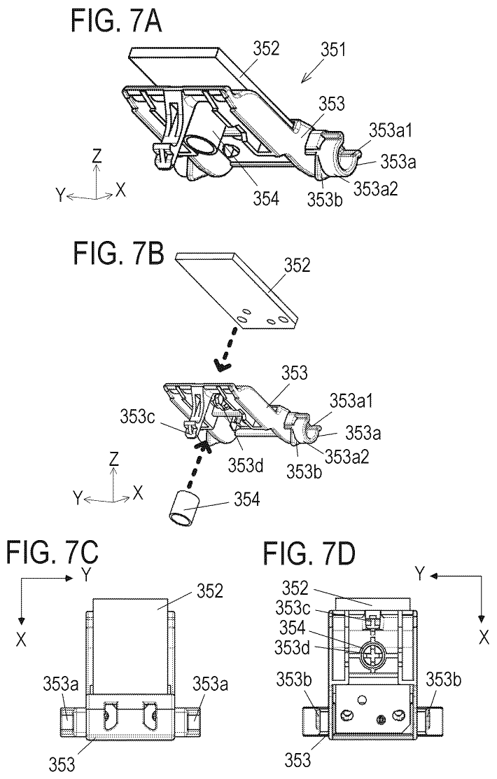

FIGS. 7A to 7D are explanatory views of the separation unit 351. The coordinate systems shown in FIGS. 7A to 7D indicate the directions when the separation unit 351 is mounted on the placement table 301 and positioned to separate the sheet 310. FIG. 7A is a perspective view of the separation unit 351. FIG. 7B is an exploded perspective view of the separation unit 351. FIG. 7C is a top view of the separation unit 351. FIG. 7D is a bottom view of the separation unit 351. The separation unit 351 is composed of a separation resistance member 352, a holding member 353 that holds the separation resistance member 352, and an urging member 354 that urges the holding member 353.

The sheets 310 placed on the placement table 301 are conveyed by the pick-up roller 304 to a separation nip portion (sandwiching portion) between the separation unit 351 and the separation roller 355. Then, the separation unit 351 exerts a separation action on the sheets 310 such that only the top sheet 310 on the placement table 301 among those conveyed by the pick-up roller 304 is sandwiched by the separation nip portion. At this time, the separation unit 351 is arranged such that the separation resistance member 352 contacts the sheets 310.

The separation resistance member 352 is configured to contact the conveyed sheet 310 in a stopped state and apply an urging pressure to the sheet 310 by the urging member 354. The separation resistance member 352 and the urging member 354 are attached to the holding member 353 so as to sandwich the holding member 353 therebetween. The separation resistance member 352 is an elastic material having flexibility and may be made of, for example, silicone rubber or the like. With this configuration, it becomes possible to hinder the movement of the sheet 310 in the conveyance direction using the frictional force between the separation resistance member 352 and the sheet 310 and separate the sheet 310. Furthermore, the separation resistance member 352 deteriorates over time due to friction or the like caused by sliding against the sheet 310. Therefore, in order to periodically replace the separation resistance member 352, the separation unit 351 is configured to be detachable from the placement table 301.

The holding member 353 has a bearing 353a, a protruding portion 353b, and a hooking portion 353c. The bearing 353a and the protruding portion 353b are provided at both ends of the holding member 353 in the Y direction. The hooking portion 353c is provided singly at the central portion of the holding member 353 in the Y direction.

As shown in FIG. 6C, the placement table 301 has, in addition to the support shaft 301a that engages with the bearing 353a, a wall portion 301b that contacts the protruding portion 353b, and a hook fixing portion 301c that serves as a locking portion for fixing (locking) a hooking portion 353c, which serves as a locked portion. In fact, the support shaft 301a consists of two support shafts 301a corresponding to the bearings 353a, the wall portion 301b consists of two wall portions 301b corresponding to the protruding portions 353b, and the hook fixing portion 301c consists of one hook fixing portion 301c corresponding to the hooking portion 353c. In FIG. 6C, the wall portions 301b are enclosed by the dotted line.

The bearing 353a is a bearing portion that extends in the Y direction. The bearing 353a has an opening 353a1 through which the support shaft 301a serving as a shaft portion is allowed to pass, and is formed to have a substantially C-shaped cross section in a plane orthogonal to the Y direction. Furthermore, the protruding portion 353b has a substantially triangular shape in a view along the Y direction and is formed to protrude on the side opposite to the opening 353a1 from the outer peripheral surface of a non-opening portion 353a2 of the bearing 353a.

The holding member 353 further has a press-fitting portion 353d into which the urging member 354 is press-fitted. The press-fitting portion 353d is provided singly at the central portion of the holding member 353 in the Y direction and is positioned between the bearing 353a and the hooking portion 353c in the X direction. The urging member 354 urges the holding member 353 in a direction in which the holding member 353 is caused to rotate so that the separation resistance member 352 approaches the separation roller 355.

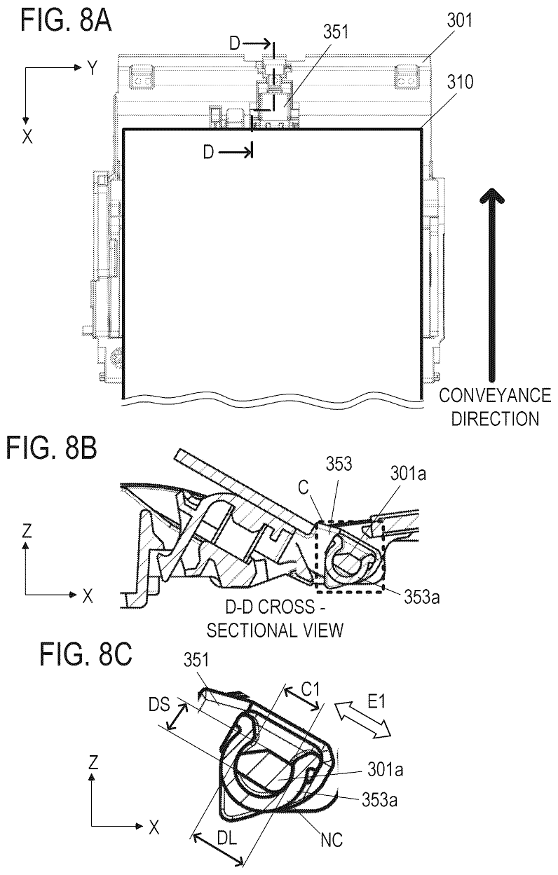

The configuration of the separation unit 351 to be mounted on the apparatus body will be described in more detail. FIGS. 8A to 8C are explanatory views showing the mounting state of the separation unit 351. FIG. 8A is a top view of the placement table 301 on which the separation unit 351 is mounted. FIG. 8B is a cross-sectional view taken along the line D-D in FIG. 8A and shows the mounting state of the separation unit 351 with respect to the placement table 301. FIG. 8C is an enlarged view of a C-portion enclosed by the dotted line in FIG. 8B.

The separation unit 351 is positioned on the downstream side in the conveyance direction of the sheet 310 relative to the placement table 301 and is arranged at the central portion of the placement table 301 in the width direction (Y direction). The bearing 353a of the holding member 353 is detachably attached to the placement table 301 by the support shaft 301a of the placement table 301.

The separation unit 351 is supported on the placement table 301 to be rotatable about the bearing 353a. At this time, the direction of the rotational axis of the separation unit 351 is parallel to the Y direction. In the following description, the position in which the separation unit 351 contacts and separates the sheet 310 fed from the placement table 301 will be defined as a first position, and the position in which the separation unit 351 is detachable from the placement table 301 will be defined as a second position.

The width (the length in the direction orthogonal to the Y direction) of an opening 353a1 of the bearing 353a is defined as a first length C1. Furthermore, the length of the cross section of the support shaft 301a in the longitudinal direction is defined as a longitudinal width DL, and the length of the cross section of the support shaft 301a in the lateral direction, which crosses the longitudinal direction, is defined as a lateral width DS. In the first embodiment, the longitudinal width DL is greater than the first length C1, while the lateral width DS is smaller than the first length C1. In the first embodiment, the longitudinal direction and the lateral direction of the support shaft 301a are substantially orthogonal to each other. Furthermore, both the longitudinal direction and the lateral direction of the support shaft 301a are directions that cross the horizontal direction (X direction and Y direction) and the gravity direction (Z direction).

FIGS. 8B and 8C show a state in which the separation unit 351 is in the first position. The second position is the position in which the separation unit has rotated in the clockwise direction in FIG. 8B from the first position. The direction of rotation at this time corresponds to the direction in which the urging member 354 urges the holding member 353.

The width direction (the direction of a first length C1) of the opening 353a1 when the separation unit 351 is in the first position is defined as a first direction E1. Furthermore, the width of the support shaft 301a in the first direction E1 when the separation unit 351 is in the first position is defined as a second length. In the first embodiment, the first direction E1 is substantially parallel to the longitudinal direction of the support shaft 301a. Accordingly, when the separation unit 351 is in the first position, the second length of the support shaft 301a is the longitudinal width DL, which is greater than the first length C1, thereby preventing the separation unit 351 from becoming detached from the bearing 353a.

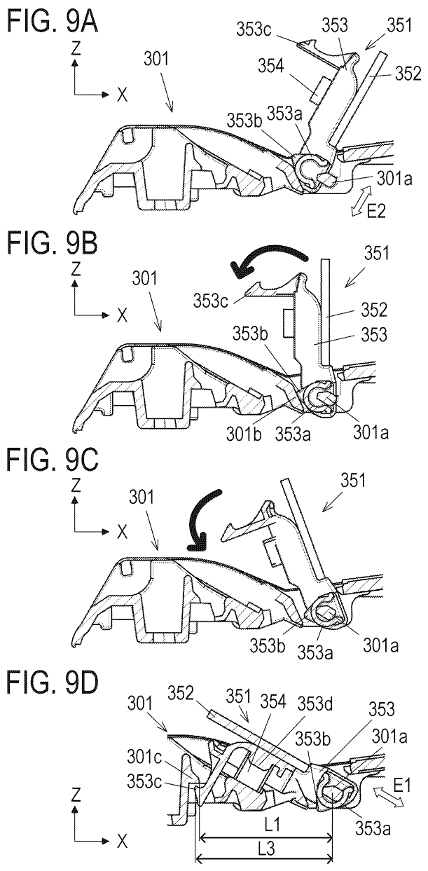

The width direction (the direction of the first length C1) of the opening 353a1 when the separation unit 351 is in the second position is defined as a second direction E2 (shown in FIG. 9A). Furthermore, the width of the support shaft 301a in the second direction E2 when the separation unit 351 is in the second position is defined as a third length. In the first embodiment, the second direction E2 is substantially parallel to the lateral direction of the support shaft 301a. Accordingly, when the separation unit 351 is in the second position, the third length of the support shaft 301a is the lateral width DS, which is smaller than the first length C1, thereby allowing the separation unit 351 to be removed from the bearing 353a such that the support shaft 301a passes through the opening 353a1. As described above, in the first embodiment, the bearing 353a is C-shaped, and the support shaft 301a is substantially oval. As a result, attachment and detachment operations are easy, and the workability of replacing the separation unit 351 (separation resistance member 352) is excellent.

Moreover, when the separation unit 351 is in the first position, the opening 353a1 of the bearing 353a is open upward in the gravity direction (Z direction) and is positioned above the support shaft 301a in the gravity direction. Accordingly, even if a user lifts the separation unit 351 from the placement table 301, the support shaft 301a, which is in contact with the non-opening portion 353a2 of the bearing 353a, restricts the movement of the separation unit 351. This configuration prevents the separation unit 351 from becoming unintentionally detached.

When the separation unit 351 is in the first position, the support shaft 301a contacts the inner peripheral surfaces of the bearings 353a at two points at both ends in the longitudinal direction. More specifically, when the separation unit 351 is in the first position, the support shaft 301a contacts the portion of the inner peripheral surface of the bearing 353a that faces the upper side in the gravity direction and the downstream side in the conveyance direction, as well as the portion that faces the lower side in the gravity direction and the upstream side in the conveyance direction. Similarly, when the sheet 310 contacts the separation resistance member 352 of the separation unit 351, the holding member 353 is prevented from moving in the conveyance direction or the vertical direction. Accordingly, the mounting position of the separation unit 351 with respect to the placement table 301 is stabilized, thereby making it possible to suppress a reduction in sheet separability.

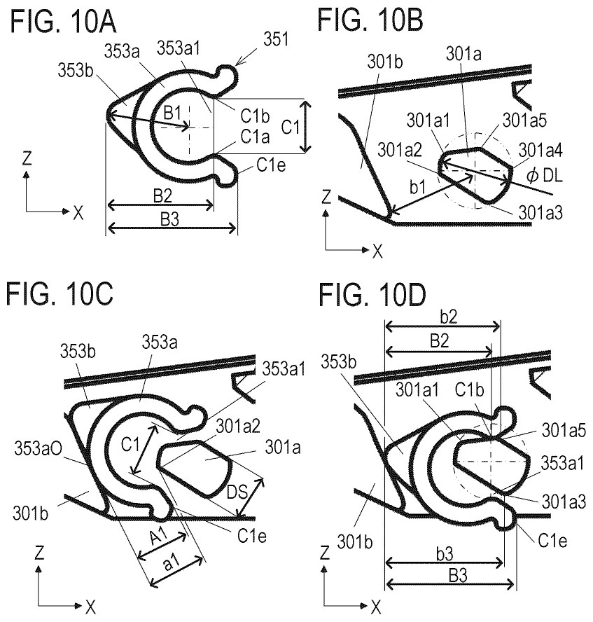

Next, a method for mounting (assembling) the separation unit 351 on the placement table 301 (apparatus body 300a) will be described in more detail with reference to FIGS. 9A to 9D and FIGS. 10A to 10D. FIGS. 9A to 9D are explanatory views showing the method for mounting the separation unit 351, each showing a cross-sectional view of the separation unit 351 and the placement table 301 taken along the line D-D in FIG. 8A. FIGS. 10A to 10D are explanatory views of the bearing 353a and the support shaft 301a, each showing an enlarged view of the bearing 353a and the support shaft 301a.

FIG. 9A shows a state in which the bearing 353a of the separation unit 351 is brought close to the support shaft 301a to mount the separation unit 351. At this time, the posture of the separation unit 351 is such that the width direction of the opening 353a1 of the bearing 353a is substantially parallel to the lateral direction of the support shaft 301a. By bringing the separation unit 351 close to the placement table 301 in this posture, preparations for engaging the bearing 353a with the support shaft 301a are made.

The placement table 301 is provided with a wall portion 301b that faces the support shaft 301a in the X direction. The wall portion 301b is positioned downstream of the support shaft 301a in the conveyance direction of the sheet 310 and has a surface inclined to approach the support shaft 301a as it extends downward in the gravity direction. When the separation unit 351 is in the second position, the wall portion 301b faces the support shaft 301a in the direction in which the protruding portion 353b protrudes. Furthermore, a space for allowing the arrangement of the bearing 353a is formed between the wall portion 301b and the support shaft 301a.

In mounting the separation unit 351, the bearing 353a is first arranged between the support shaft 301a and the wall portion 301b as shown in FIG. 9A. At this time, the separation unit 351 may be brought close to the placement table 301 such that the outer peripheral surface of the bearing 353a contacts the wall portion 301b, thereby allowing the user to stably operate the separation unit 351.

FIG. 9B shows a state in which the separation unit 351 has been rotated from the state shown in FIG. 9A in a direction (counterclockwise direction in the figure) in which the urging member 354 and the hooking portion 353c are brought closer to the placement table 301. FIG. 9B shows the orientation when the separation unit 351 extends straight and the extending direction of the separation resistance member 352 is vertical (parallel to the Z direction). In FIG. 9B, the protruding portion 353b is in contact with the wall portion 301b, and the support shaft 301a is positioned across the inside and outside of the bearing 353a with its part positioned within the opening 353a1. The position of the separation unit 351 in FIG. 9B is defined as a third position. The separation unit 351 is configured to be movable to this third position during the process of mounting and removing operations.

When the separation unit 351 is rotated, the protruding portion 353b, which protrudes in the direction opposite to the opening direction of the opening 353a1, contacts the wall portion 301b. Then, the protruding portion 353b receives a force from the wall portion 301b in the direction toward the support shaft 301a. That is, as the separation unit 351 is rotated, the separation unit 351 receives a force from the wall portion 301b via the protruding portion 353b so that the support shaft 301a passes through the opening 353a1. In other words, the separation unit 351 is guided by the force received from the wall portion 301b so that the bearing 353a engages with the support shaft 301a. This configuration allows an improvement in operability when the separation unit 351 is mounted.

FIG. 9C shows a state in which the separation unit 351 has been rotated from the state shown in FIG. 9B in a direction in which the urging member 354 and the hooking portion 353c are brought closer to the placement table 301 (counterclockwise direction in the figure). At this time, the entire support shaft 301a is positioned inside the bearing 353a and engages with the bearing 353a, with the both ends of the support shaft 301a in the longitudinal direction contacting the inner peripheral surface of the bearing 353a.

In the above example, the separation unit 351 is rotated to bring the protruding portion 353b into contact with the wall portion 301b, thereby engaging the bearing 353a with the support shaft 301a. However, the engagement is not limited to this method. For example, by translating the separation unit 351 and engaging the bearing 353a with the support shaft 301a, the state shown in FIG. 9B may be shifted to the state shown in FIG. 9C. In other words, even during the mounting operation of the separation unit 351, the separation unit 351 is allowed to move to the second position in which the width direction (the direction of the first length C1) of the opening 353a1 is substantially parallel to the lateral direction of the support shaft 301a.

FIG. 9D shows a state in which the separation unit 351 has been rotated from the state shown in FIG. 9C in the direction in which the urging member 354 and the hooking portion 353c are brought closer to the placement table 301 (counterclockwise direction in the figure). In FIG. 9D, the separation unit 351 is in the first position in which the separation unit 351 separates the sheet 310 supplied from the placement table 301.

When the separation unit 351 is in the first position, the hooking portion 353c engages with the hook fixing portion 301c of the placement table 301. As a result, the upward movement of the hooking portion 353c is restricted. Specifically, the hooking portion 353c is positioned below the hook fixing portion 301c. In the X direction, a distance L1 from the rotation center of the separation unit 351 (the shaft center of the support shaft 301a) to the hooking portion 353c is greater than a distance L3 from the rotation center of the separation unit 351 to the hook fixing portion 301c. With this configuration, the hook fixing portion 301c restricts the movement (rotation) of the separation unit 351 from the first position to the second position. In other words, in the first embodiment, while being urged by the urging member 354 in the rotating direction from the first position to the second position, the separation unit 351 is restricted by the hook fixing portion 301c from moving to the second position, thereby fixing the posture of the separation unit 351. Note that the hooking portion 353c and the hook fixing portion 301c have a snap-fit configuration in which their locked state is releasable by pressing and elastically deforming the hooking portion 353c.

Next, a method for removing the separation unit 351 will be described. When the separation unit 351 is removed from the placement table 301 (the apparatus body 300a), it is rotated in the clockwise direction in the figure from the first position (the position shown in FIG. 9D). On the downstream side of the hooking portion 353c in the conveyance direction of the sheet 310, a space is formed that allows the user to press the hooking portion 353c with a finger. Accordingly, the user may release the locked state between the hooking portion 353c and the hook fixing portion 301c by pressing and elastically deforming the hooking portion 353c with a finger. Furthermore, the hook fixing portion 301c has an upwardly-protruding shape and prevents the separation unit 351 from rotating toward the second position due to unintentional pressing of the hooking portion 353c.

By rotating the separation unit 351 from the first position to the second position and translating it in a posture in which the width direction of the opening 353a1 is substantially parallel to the lateral direction of the support shaft 301a, the engagement between the bearing 353a and the support shaft 301a may be released. As described above, the lateral width DS, which is the length of the support shaft 301a in the lateral direction, is configured to be smaller than the first length C1, which is the length of the opening 353a1 in the width direction, thereby allowing the user to remove the separation unit 351 with excellent workability.

Note that in the first embodiment, the width direction (first direction E1) of the opening 353a1 is substantially parallel to the longitudinal direction of the support shaft 301a when the separation unit 351 is in the first position. Moreover, the width direction (second direction E2) of the opening 353a1 is configured to be substantially parallel to the lateral direction of the support shaft 301a when the separation unit 351 is in the second position. However, the present invention is not limited to this configuration. Specifically, the second length, which is the width of the support shaft 301a in the first direction E1, needs only to be greater than the first length when the separation unit 351 is in the first position, and the third length, which is the width of the support shaft 301a in the second direction E2, needs only to be smaller than the first length when the separation unit 351 is in the second position. This configuration allows for stable sheet separability while improving the detachment operability of the separation unit 351 even if the longitudinal direction of the support shaft 301a crosses the first direction E1.

With reference FIGS. 10A to 10D, a state in which the separation unit 351 shifts from the state shown in FIG. 9A to the state in shown FIG. 9B will be described in more detail. FIG. 10A shows the bearing 353a when the separation unit 351 is in the posture shown in FIG. 9B. FIG. 10B shows the configuration of the periphery of the support shaft 301a and the wall portion 301b of the placement table 301. FIGS. 10C and 10D show the positional relationship between the bearing 353a and the support shaft 301a.

As shown in FIG. 10A, the opening 353a1 of the bearing 353a is formed between ends C1a and C1b. In the posture shown in FIG. 10A, the end C1b is positioned above the end C1a, and the positions of the ends C1a and C1b in the X direction are substantially the same. The ends C1a and C1b are connected by a curved surface with a fixed radius. When the support shaft 301a engages with the bearing 353a, the curved surface contacts the support shaft 301a. Furthermore, inclined surfaces extending linearly and at an angle are formed from the ends C1a and C1b such that the distance between them increases. This configuration guides the support shaft 301a toward the opening 353a1 when the separation unit 351 is mounted. Furthermore, the protruding portion 353b protrudes in the direction opposite to the opening 353a1 relative to the center of the bearing 353a in the X direction.

The distance from the rotation center of the bearing 353a to the tip of the protruding portion 353b is defined as a distance B1. Furthermore, in the posture shown in the figure, the distance in the X direction from the tip of the protruding portion 353b to the opening 353a1 (ends C1a and C1b) is defined as a distance B2, and the distance in the X direction from the tip of the protruding portion 353b to an opening end Cle is defined as a distance B3. In the first embodiment, the relationship between these distances is expressed as B1<B2<B3.

As shown in FIG. 10B, the distance from the shaft center of the support shaft 301a to the end of the wall portion 301b is defined as a distance b1. The cross section of the support shaft 301a has an irregular shape having inflection points 301a1, 301a2, 301a3, 301a4, and 301a5. The cross-sectional shape of the support shaft 301a is formed by a line that connects these inflection points 301a1 to 301a5.

In the support shaft 301a, the inflection points 301a1, 301a2, 301a3, 301a4, and 301a5 are arranged in this order in the counterclockwise direction shown in FIG. 10B. The inflection points 301a1 and 301a2 are connected by an arc with a diameter of φ DL, which is centered on the shaft center of the support shaft 301a, extending downward in the gravity direction. The inflection points 301a2 and 301a3 are connected by a line extending in a direction away from the wall portion 301b and downward in the gravity direction. The inflection points 301a3 and 301a4 are connected by an arc with a diameter of φ DL, which is centered on the shaft center of the support shaft 301a, extending upward in the gravity direction. The inflection points 301a4 and 301a5 are connected by a line extending in a direction approaching the wall portion 301b and upward in the gravity direction. The inflection points 301a5 and 301a1 are connected by a line extending in a direction approaching the wall portion 301b and downward in the gravity direction. Note that the inflection point 301a5 is positioned on the inner side (on the shaft center side) of the arc with a diameter of φ DL.

FIG. 10C shows a state in which both the outer peripheral surface of the bearing 353a and the protruding portion 353b are in contact with the wall portion 301b. In this state, the distance from the wall portion 301b to the opening end Cle is defined as a distance A1, and the distance from the wall portion 301b to the inflection point 301a2 is defined as a distance a1. In the first embodiment, the relationship A1<a1 is satisfied in the state shown in FIG. 10C. Furthermore, in this state, the width direction (the direction indicated by the distance C1) of the opening 353a1 and the lateral direction (the direction indicated by the lateral width DS) of the support shaft 301a are substantially parallel to each other. With this configuration, the relationship C1>DS may facilitate the attachment of the bearing 353a to the protruding portion 353b.

FIG. 10D shows a state in which the separation unit 351 is in the posture shown in FIG. 9B, and the bearing 353a is spaced apart from the wall portion 301b, with the protruding portion 353b contacting the wall portion 301b. In this state, the distance from the contact point between the protruding portion 353b and the wall portion 301b to the inflection point 301a5 is defined as a distance b2. Furthermore, the distance from the contact point between the protruding portion 353b and the wall portion 301b to the end C1b of the opening 353a1 is the aforementioned distance B2, and the relationship B2<b2 is satisfied. Moreover, the inflection point 301a1 is positioned below the inflection point 301a5 in the gravity direction. These configurations may prevent the end C1b of the bearing 353a from getting caught by the inflection points 301a1 and 301a5 when the bearing 353a rotates toward the side where it is attached to the protruding portion 353b.

Moreover, in FIG. 10D, the distance from the contact point between the protruding portion 353b and the wall portion 301b to the inflection point 301a3 is defined as a distance b3. Furthermore, the distance from the contact point between the protruding portion 353b and the wall portion 301b to the opening end Cle is the aforementioned distance B3, and the relationship B3<b3 is satisfied. This configuration may prevent the opening end Cle of the bearing 353a from getting caught by the inflection point 301a3 when the bearing 353a rotates toward the side where it is attached to the protruding portion 353b. This configuration may improve the ease of attachment of the separation unit 351.

As described above, the configuration of the first embodiment stably secures the separation unit 351 at the first position, while improving the ease of detachment of the separation unit 351 from the placement table 301 (the apparatus body 300a), thereby achieving stable sheet separation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-114055, filed Jul. 17, 2024, which is hereby incorporated by reference herein in its entirety.

What is claimed is:

1. A sheet supplying apparatus comprising:
an apparatus body having a shaft portion;
a sheet stacking portion that stacks a plurality of sheets;
a supplying member that supplies each of the sheets stacked on the sheet stacking portion;
a separation unit that moves between a first position in which the separation unit contacts and separates the sheet supplied from the sheet stacking portion, and a second position in which the separation unit is rotated about the shaft portion from the first position relative to the apparatus body; and
a bearing provided in the separation unit, detachable from the shaft portion, and having an opening with a width of a first length in a width direction, wherein,
assuming that the width direction of the opening is a first direction in a case where the separation unit is in the first position and that the width direction of the opening is a second direction in a case where the separation unit is in the second position, a width of the shaft portion in the first direction is greater than the first length, while a width of the shaft portion in the second direction is smaller than the first length.

2. The sheet supplying apparatus according to claim 1, wherein
the first direction is a direction substantially parallel to a longitudinal direction of a cross section of the shaft portion, while the second direction is a direction substantially parallel to a lateral direction that crosses the longitudinal direction of the shaft portion.

3. The sheet supplying apparatus according to claim 2, wherein,
in a case where the separation unit is in the first position, the shaft portion contacts an inner peripheral surface of the bearing at both ends in the longitudinal direction.

4. The sheet supplying apparatus according to claim 3, wherein
the longitudinal direction is a direction that crosses a horizontal direction and a gravity direction.

5. The sheet supplying apparatus according to claim 1, wherein,
in a case where the separation unit is in the first position, the opening of the bearing is open upward in a gravity direction.

6. The sheet supplying apparatus according to claim 1, wherein
the separation unit includes a protruding portion that protrudes in a direction opposite to a direction in which the opening of the bearing is open,
the apparatus body is provided with a wall portion that faces a direction in which the protruding portion protrudes in a case where the separation unit is in the second position relative to the shaft portion, and
a space for allowing arrangement of the bearing is formed between the shaft portion and the wall portion.

7. The sheet supplying apparatus according to claim 6, wherein
the separation unit is configured to be movable to a third position in which the protruding portion contacts the wall portion, and the shaft portion is positioned across an inside and an outside of the bearing via the opening.

8. The sheet supplying apparatus according to claim 6, wherein
the bearing and the protruding portion are provided at both ends of the separation unit in a direction along a rotational axis of the separation unit.

9. The sheet supplying apparatus according to claim 1, wherein
the separation unit includes an elastic material having flexibility that contacts the sheet supplied from the supplying member, and a holding member that holds the elastic material and has the bearing.

10. The sheet supplying apparatus according to claim 9, further comprising
a separation roller that contacts the elastic material to form a separation nip portion, wherein
the separation unit includes an urging member that urges the holding member in a direction in which the elastic material approaches the separation roller.

11. The sheet supplying apparatus according to claim 1, wherein
the separation unit includes a locked portion, and
the apparatus body has a locking portion that engages with the locked portion in a case where the separation unit is in the first position, and restricts movement of the separation unit from the first position to the second position.

12. The sheet supplying apparatus according to claim 11, wherein
the locking portion and the locked portion have a snap-fit configuration in which a locked state is releasable by pressing and elastically deforming the locking portion with a finger.

13. An image reading apparatus comprising:
a sheet supplying apparatus; and
an image reading portion that reads an image from a sheet supplied from the sheet supplying apparatus,
the sheet supplying apparatus including
an apparatus body having a shaft portion,
a sheet stacking portion that stacks a plurality of sheets,
a supplying member that supplies each of the sheets stacked on the sheet stacking portion,
a separation unit that moves between a first position in which the separation unit contacts and separates the sheet supplied from the sheet stacking portion, and a second position in which the separation unit is rotated about the shaft portion from the first position relative to the apparatus body, and
a bearing provided in the separation unit, detachable from the shaft portion, and having an opening with a width of a first length in a width direction, wherein,
assuming that the width direction of the opening is a first direction in a case where the separation unit is in the first position and that the width direction of the opening is a second direction in a case where the separation unit is in the second position, a width of the shaft portion in the first direction is greater than the first length, while a width of the shaft portion in the second direction is smaller than the first length.

14. A recording apparatus comprising:
a sheet supplying apparatus; and
an image recording portion that records an image on a sheet supplied from the sheet supplying apparatus,
the sheet supplying apparatus including
an apparatus body having a shaft portion,
a sheet stacking portion that stacks a plurality of sheets,
a supplying member that supplies each of the sheets stacked on the sheet stacking portion,
a separation unit that moves between a first position in which the separation unit contacts and separates the sheet supplied from the sheet stacking portion, and a second position in which the separation unit is rotated about the shaft portion from the first position relative to the apparatus body, and
a bearing provided in the separation unit, detachable from the shaft portion, and having an opening with a width of a first length in a width direction, wherein,
assuming that the width direction of the opening is a first direction in a case where the separation unit is in the first position and that the width direction of the opening is a second direction in a case where the separation unit is in the second position, a width of the shaft portion in the first direction is greater than the first length, while a width of the shaft portion in the second direction is smaller than the first length.
